(19) United States
(12) Patent Application Publication
(10) Pub. No.: US 2005/0174116 A1
(43) Pub. Date: Aug. 11, 2005

(54) Open mr system provided with transmission rf coil arrays

(75) Inventors: Christoph G. Leussler, Hamburg (DE); Volkmar Schulz, Lubeck (DE)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N.V., 5621 BA Eindhoven (NL)

(21) Appl. No.: 10/517,931

(22) PCT Filed: Jun. 11, 2003
(86) PCT No.: PCT/IB03/02210

(30) Foreign Application Priority Data
Jun. 14, 2002 (DE) 102 26 511.9

(51) Int. Cl. G01V 3/00

(52) U.S. Cl. 324/318

(57) ABSTRACT

The invention relates to an open MR system in which the magnetic RF field is to be adjusted at will in respect of field profile. This is achieved in accordance with the invention by providing an RF coil system for the transmission and/or reception of RF signals, which RF coil system includes two RF coil arrays which are arranged on opposite sides of the examination zone, each RF coil array including at least two RF coils which are decoupled from one another and are connected to a respective channel of a transmit/receive unit. The invention also relates to a corresponding planar RF coil array.

The invention relates to a magnetic resonance system (MR system) for MR imaging as well as to an RF coil array for an RF coil system of such an MR system, notably for an open MR system.

An open MR system of this kind is known from EP 1 059 539 A2. The cited document describes a whole-body RF coil system which includes a first and a second RF coil array which are arranged on opposite sides of the examination zone so as to be phase shifted 90° relative to one another. In order to generate a rotating B₁ magnetic field in the examination zone, the RF coil arrays operate with a network in which a fixed phase relationship exists between the individual orthogonally arranged sub-coils of the RF coil arrays. The two RF coil arrays thus are hard-wired to one another and operate with a fixed amplitude and phase relationship.

In open MR systems of this kind, involving a steady main magnetic field in the vertical direction, it is in principle necessary for the RF coil system to generate a homogeneous RF magnetic field which is oriented orthogonally to the steady main magnetic field. A number of different RF coil systems has been proposed for this purpose; like the RF coil system described in the cited EP 1 059 539 A2, such systems are capable of generating a rotating RF magnetic field. The object of such RF coil systems invariably was the generation of an RF magnetic field having the highest possible homogeneity in the examination zone. RF coil systems of this kind, however, are not particularly suitable for techniques used for special MR imaging methods such as, for example, the SENSE method, because the homogeneity of the RF magnetic field is predefined and fixed and cannot be interactively modified and controlled during an MR data acquisition or between MR data acquisitions.

Therefore, it is an object of the present invention to provide an MR system as well as an RF coil array for an RF coil system of an MR system which enable variation and control of the RF field, possibly in respect of time as well as position, during an MR data acquisition.

This object is achieved in accordance with the invention by means of an MR system as disclosed in claim 1 which includes:
an open main field magnet with two main field magnet poles which are arranged on opposite sides of an examination zone and serve to generate a magnetic main field;
a gradient coil system with a plurality of gradient coils for generating magnetic gradient fields;
an RF coil system for transmitting and/or receiving RF signals with two planar RF coil arrays which are situated on opposite sides of the examination zone, each RF coil array including at least two RF coils which are decoupled from one another and are connected to a respective channel of a transmit/receive unit;
a transmit/receive unit which includes a respective channel for an RF coil of the RF coil system, each RF coil being separately controllable in the transmission mode;
a control unit for controlling the MR imaging; and
a processing unit for processing received MR signals.

A corresponding planar RF coil array for an RF coil system of such an MR system is disclosed in claim 9.

The invention is based on the idea to refrain from hard-wiring the individual RF coils of the RF coil arrays to one another and from operating the coil arrays with a fixed amplitude and phase relationship, and to connect each RF coil to a separate channel of a transmit/receive unit instead, thus enabling separate control of each RF coil. Each RF coil can thus be supplied with a separate excitation pulse (in the transmission mode) and the MR signal received by each RF coil (in the receiving mode) can be separately evaluated. Each RF coil array includes at least two of such RF coils which are each time decoupled from one another, the RF coil arrays being constructed so as to be planar and being arranged on opposite sides of the examination zone.

In a preferred embodiment the RF coil arrays themselves are also decoupled from one another. This is necessary in particular for embodiments of the RF coil arrays as disclosed in the claims 4 and 6. In conformity with these preferred embodiments the RF coils are formed either by planar resonant conductors or by butterfly coils. In other embodiments, for example, the preferred embodiment disclosed in claim 5 in which the RF coils are formed by surface antennas, notably rectangular surface antennas, such decoupling of the RF coil arrays from one another can be dispensed with, notably when the individual surface antennas have a small surface area only.

Various possibilities exist for the decoupling of the individual RF coils from one another. Preferred and simple steps are disclosed in claim 3.

As is disclosed in claim 7, the RF coils of an RF coil array can be arranged either on a single board or on two boards; in the latter case the means for decoupling the individual RF coils from one another are also integrated in the RF coil array, for example, in that the RF coils are accommodated on a first board and the decoupling means are accommodated on a second board.

In order to enable the generation of a rotating RF magnetic field by means of the MR system in accordance with the present invention, which field can be adjusted at will in all three spatial directions, the invention is advantageously suitable for use in conjunction with novel MR imaging methods, notably for improved and fast MR imaging methods. For example, the invention can be used when active RF control is required, in MR imaging in conformity with the SENSE method, when a local pre-saturation is required or in the case of feedback control of the RF homogeneity on the basis of mechanical changes during an MR data acquisition. In respect of the SENSE method reference is made to the publication by K. Prüssmann “SENSE: Sensitivity Encoding for Fast MRI”, Magnetic Resonance in Medicine 42: 952-962 (1999) in which this method is described in detail. The SENSE method for transmitting signals is described in ISMRM 2002, Hawai, Honolulu, p. 189, “Theory and experimental verification of transmit SENSE”. Transmit SENSE utilizes time-dependent waveforms and spatial sensitivities so as to shorten multidimensional RF pulses.

The invention will be described in detail hereinafter with reference to the drawings. Therein:

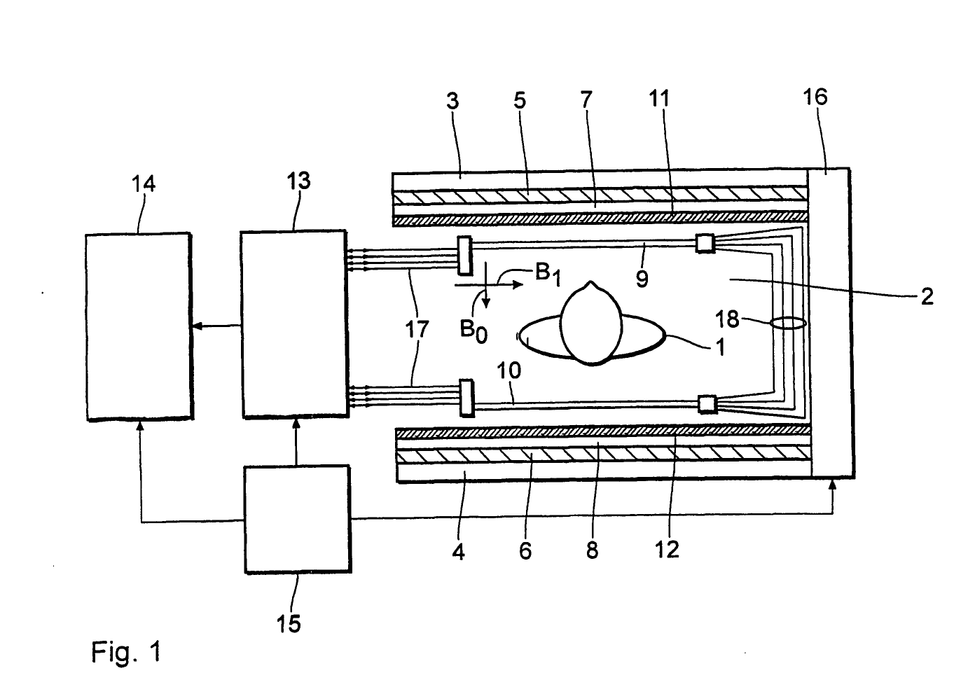

FIG. 1 is a diagrammatic representation of an MR system in accordance with the invention;

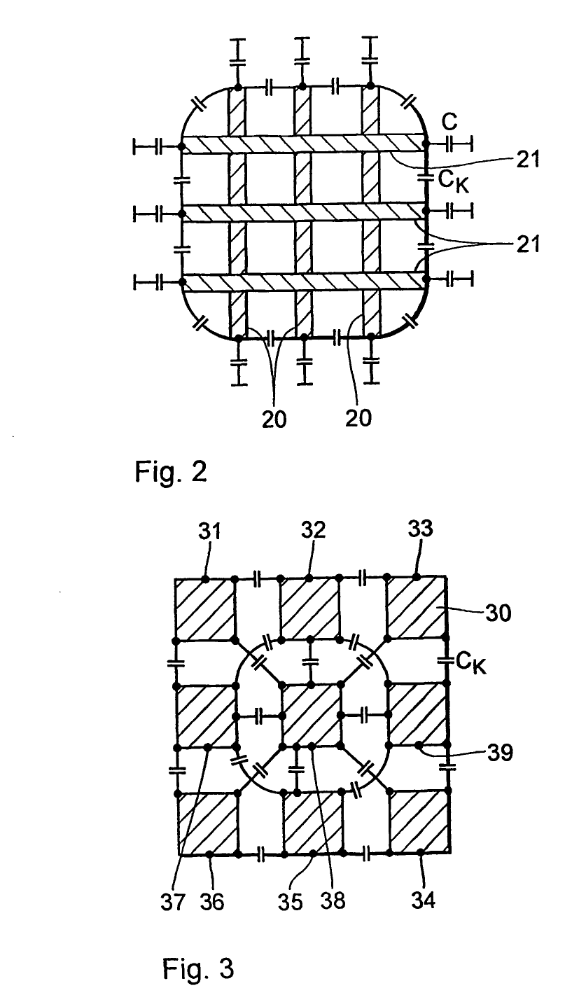

FIG. 2 shows a first embodiment of an RF coil array in accordance with the invention;

FIG. 3 shows a second embodiment of an RF coil array in accordance with the invention;

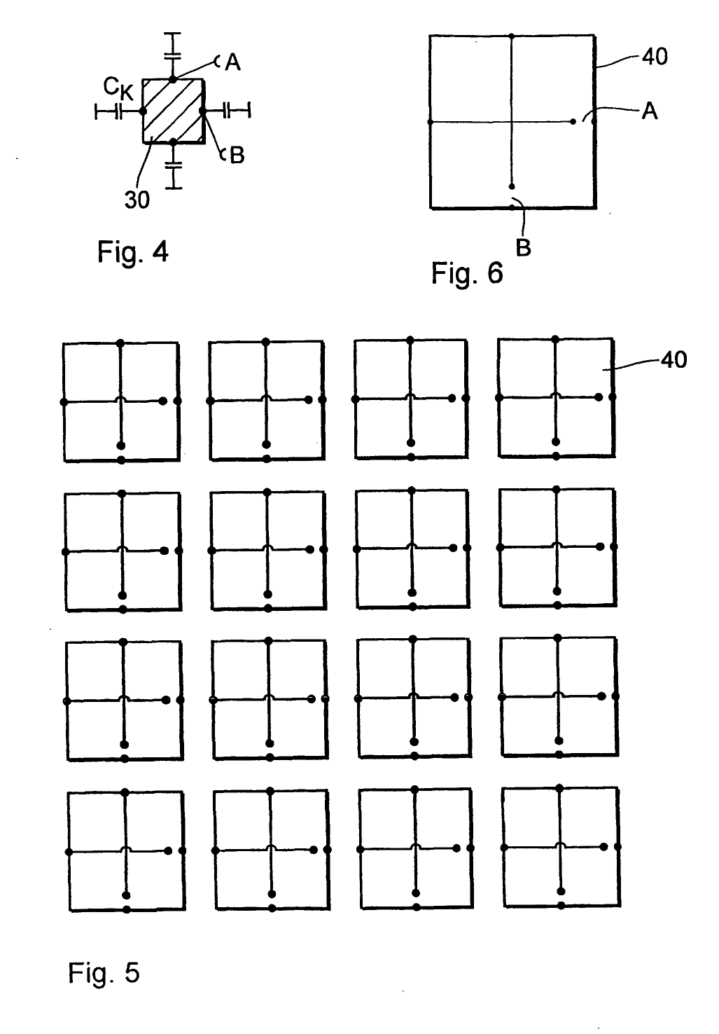

FIG. 4 shows a single surface antenna of the RF coil array in accordance with FIG. 3;

FIG. 5 shows a third embodiment of an RF coil array in accordance with the invention;

FIG. 6 shows a single RF coil of an RF coil array as shown in FIG. 5;

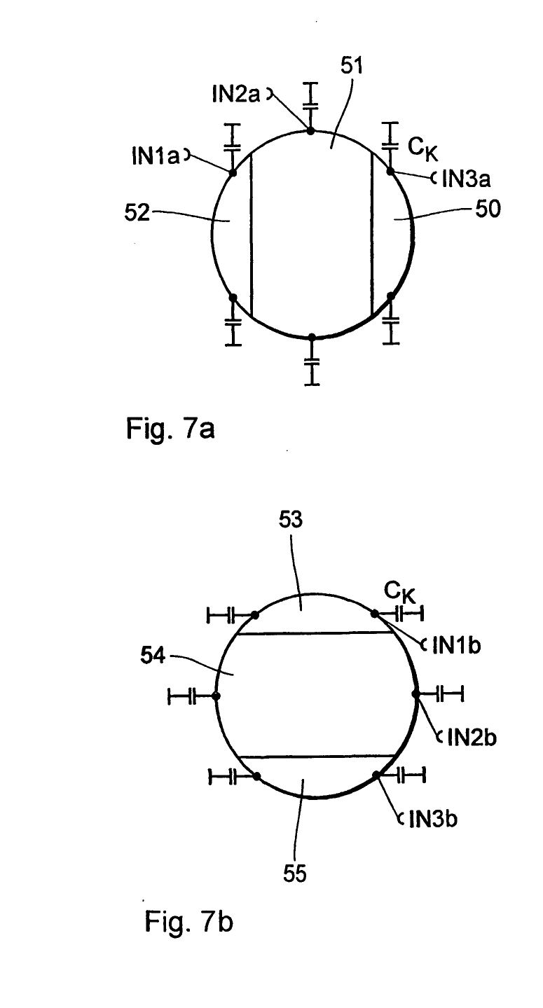

FIGS. 7a, b show a fourth embodiment of an RF coil array in accordance with the invention;

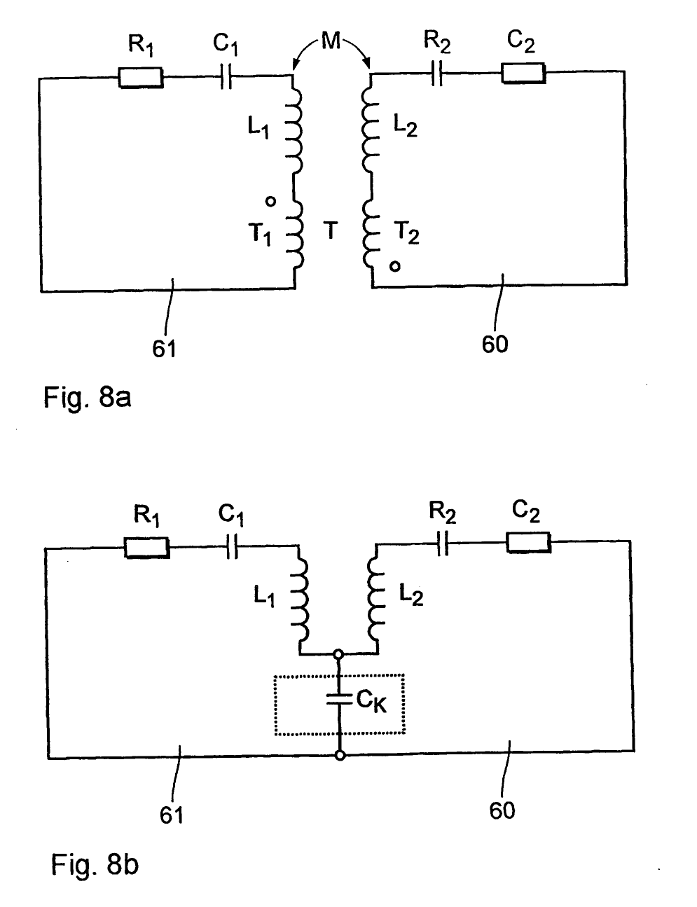

FIGS. 8a, b show two embodiments for the decoupling of two coils; and

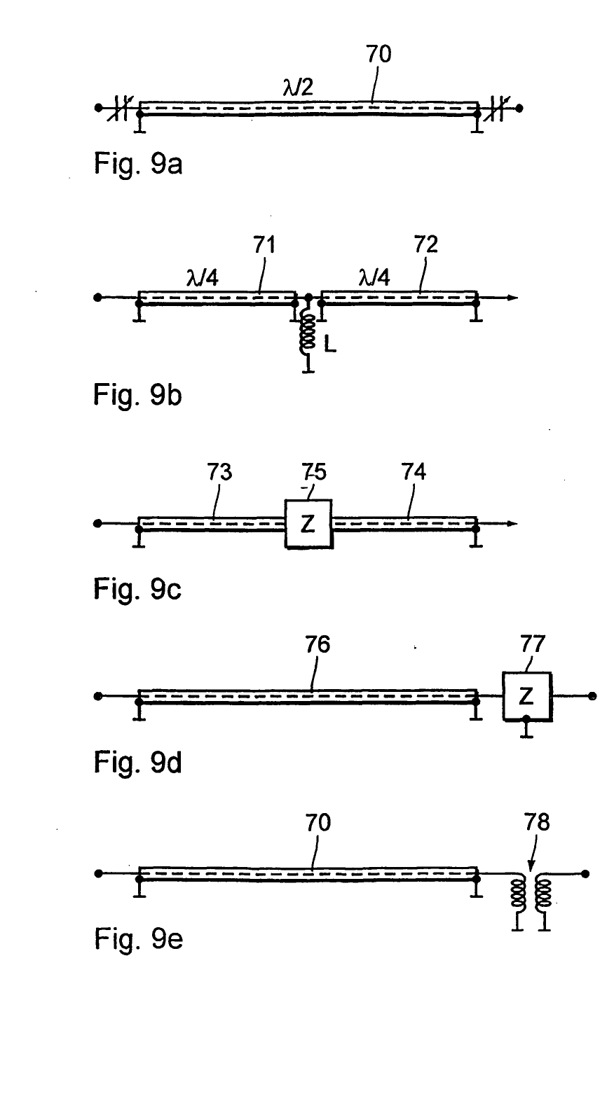

FIGS. 9a to e show further possibilities for the decoupling of coils.

FIG. 1 is a diagrammatic representation of an MR system in accordance with the invention for the formation of MR images of the part of the patient 1 which is situated in an examination zone. The patient 1 is arranged in an open space 2 between two main field magnet poles 3, 4 of a main field magnet. The main field magnet also includes a first and a second equalization plate 5, 6 which generate, in conjunction with the main field magnet poles 3, 4, a homogeneous steady magnetic field B₀ in the examination zone between the main field magnet poles 3, 4, that is in the vertical direction in the drawing. There is also provided a gradient coil system 7, 8 which includes a plurality of gradient coils for generating magnetic gradient fields in the examination zone. An RF coil system with two RF coil arrays 9, 10 is provided in order to generate a magnetic RF field B₁ in a direction which is essentially perpendicular to the steady main magnetic field B₀. Each of said RF coil arrays 9, 10 includes at least two RF coils which can act both as transmit coils for the excitation of the examination zone and as receive coils for the reception of MR signals from the examination zone. RF shields 11, 12 between the neighboring RF coil arrays 9, 10 and the neighboring gradient coils 7, 8 on the other side prevent the coupling in of the magnetic RF field B₁ into the gradient coils 7, 8.

A transmit/receive unit 13 is provided for the control of the individual RF coils of the RF coil arrays 9, 10 in the transmit mode or for the reception of the MR signals received by the individual RF coils. The transmit/receive unit 13 comprises n transmit channels which can be controlled independently of one another in order to control the phase, amplitude and waveform of the excitation signal. Moreover, n receive channels which are independent of one another are provided for the reception of MR signals. The processing of received MR signals and the generating of desired MR images are performed by a processing unit 14. The transmit/receive unit 13, the processing unit 14 and the various coil systems, coupled to one another via and mounted on a support 16, are controlled by means of a control unit 15. Further details of the basic construction of such an MR system as well as the principle of operation of such a system are generally known and, therefore, need not be further elaborated herein.

In the embodiment of the MR system in accordance with the invention as shown, each RF coil array 9, 10 includes at least two RF coils which are decoupled from one another. Each of these coils is separately connected, via a separate channel 17, to the transmit/receive unit 13 (generally speaking, an n-channel spectrometer) and can thus be separately controlled. In the embodiment shown, four channels 17 are provided for each RF coil array 9, 10, so that each RF coil array may include four RF coils. Moreover, the RF coil arrays 9, 10 are decoupled from one another by decoupling leads 18. Using such a design, the homogeneity of the RF field B₁ can be optimally controlled in all three spatial directions during the MR data acquisition and the excitation, thus enabling various applications such as, for example, qaudrature-homogeneous, quadrature-synergy/SENSE, transmit/receive SENSE.

FIG. 2 shows a first embodiment of an RF coil array in accordance with the invention which is suitable for use in an MR system as shown in FIG. 1. This planar antenna array has a number of strip antennas 20, 21, the ends of each of which are grounded by means of capacitances C. In the embodiment shown, each time three strip antennas 20 are provided so as to extend horizontally in the plane of drawing and also three strip antennas 21 are provided so as to extend perpendicularly thereto. For the magnetic decoupling of the individual strip antennas 20, 21 from one another, respective decoupling capacitances C_{K} are provided each time between the ends of two neighboring strip antennas.

FIG. 3 shows a further embodiment of an RF array in accordance with the invention. This planar RF array includes a number of individual planar surface antennas 30 which are arranged in the form of a grid, for example, on a single board, for example, on a PCB substrate. In order to decouple the individual surface antennas 30 from one another, decoupling capacitors C_{K} are again provided, notably in the manner shown in FIG. 3. The intrinsic magnetic coupling between the surface antennas 30 can thus be suppressed by calculation of the matrix elements Mᵢⱼ and by utilizing suitable capacitance values for these decoupling capacitances C_{K}. Because the surface areas of the individual surface antennas 30 are comparatively small, however, no decoupling is required between an upper and a lower RF coil array when such RF coil arrays are used in the MR system shown in FIG. 1.

The connection points of the individual surface antennas 30 to the respective associated channel of the transmission/receive unit are denoted by the references 31 to 39 in FIG. 3. FIG. 4 is a more detailed representation of a single surface coil which is suitable for use in the RF coil array shown in FIG. 3. This surface coil comprises a decoupling capacitance C_{K} which is connected to ground at each end and via which it can be connected to further surface coils 30. Moreover, two inputs A, B are provided for coupling to the transmit/receive unit so as to generate a circular rotary field.

FIG. 5 is a diagrammatic representation of a third embodiment of an RF coil array in accordance with the invention. It includes a number of butterfly coils 40 which are arranged in the form of a grid and hence form a two-dimensional grid. In the present case there are provided 16 butterfly coils so that also 16 channels of the transmit/receive unit must be provided for such an RF coil array. FIG. 6 shows a single butterfly coil 40. This coil again includes two inputs A, B for different control, that is for control with a different amplitude, phase and/or waveform in the transmission mode.

Each of the FIGS. 7a, b shows an embodiment of an RF coil system in accordance with the invention, each of which has a two-layer design. FIG. 7a shows an RF coil array with three R° F. coils 50, 51, 52 which are decoupled by way of each time two decoupling capacitances C_{K} relative to ground. The coupling in or out of signals is performed on the three inputs IN1a, IN2a, IN3a. FIG. 7b shows a similar RF coil array with three RF coils 53, 54, 55, said RF coils 53, 54, 55, however, being rotated through 90° in the plane of drawing. The coupling in and out of signals is then performed via the connections IN1b, IN2b, fN3b. The RF coil array shown in FIG. 7a can be used, for example, as the upper RF coil array (9 in FIG. 1) and the RF coil array shown in FIG. 7b can be used as the lower RF coil array (10 in FIG. 1). The superposed RF fields of these RF coil arrays then produce a rotating RF component which can be formed at will in all three spatial directions.

FIG. 8 shows two possibilities for the decoupling of two coils. FIG. 8a shows two coils 60, 61, or their equivalent diagrams, consisting of a resistance R, a capacitance C and an ideal coil L, which components are coupled to one another via the coupling factor M.

For the decoupling of the coils 60, 61 from one another there is provided a transformer T whose windings T1 and T2 have an opposed winding sense and hence decouple the coils from one another.

As an alternative, in FIG. 8b a decoupling capacitor C_{K} is provided for the decoupling of the two coils 60, 61, the value of said capacitance being such that the following holds: 1/(ωC_{K})=ωM.

FIG. 9 shows further possibilities for the decoupling which are suitable in particular for the decoupling of the individual RF coils within an RF coil array. FIG. 9a shows an RF cable 70 in the form of a coaxial cable having a length λ/2, the coils to be decoupled being connected to the end thereof. FIG. 9b shows two RF cables 71, 72, each having a length λ/4, wherebetween a coil L is connected to ground. FIG. 9c shows two RF cables 73, 74 of different length wherebetween an impedance transformation circuit 75 is provided. FIG. 9d shows an RF cable of the length 76, to the end of which there is connected an impedance transformation circuit 77. FIG. 9e shows the decoupling by means of a transformer 78. It is to be noted that the decoupling possibilities shown in the FIGS. 8 and 9 represent preferred embodiments and that in principle other possibilities can also be used for the decoupling of individual RF coils from one another or of the RF coil arrays from one another.

In accordance with the invention it is also feasible to use an MR RF amplifier which preferably comprises n inputs and n outputs in a common rack. Furthermore, circulators can be provided each time between the coils and the amplifiers in order to suppress reverse effects on the amplifiers.

In accordance with the invention it is thus achieved that the magnetic RF field B₁ can be adjusted at will in respect of field profile, that is, also during the MR data acquisition. Novel methods and techniques for MR imaging can thus be carried out by means of the MR system in accordance with the invention.

1. An MR system for MR imaging, including:
an open main field magnet with two main field magnet poles which are arranged on opposite sides of an examination zone in order to generate a magnetic main field;
a gradient coil system with a plurality of gradient coils for generating magnetic gradient fields;
an RF coil system for transmitting and/or receiving RF signals with two planar RF coil arrays which are situated on opposite sides of the examination zone, each RF coil array including at least two RF coils which are decoupled from one another and are connected to a respective channel of a transmit/receive unit;
a transmit/receive unit which includes a respective channel for an RF coil of the RF coil system, each RF coil being separately controllable in the transmission mode;
a control unit for controlling the MR imaging; and
a processing unit for processing received MR signals.

2. An MR system as claimed in claim 1, wherein the two RF coil arrays are decoupled from one another.

3. An MR system as claimed in claim 1, wherein RF cables, notably of the length λ/2 or λ4, capacitances, impedance circuits and/or transformers are provided for the decoupling of the individual RF coils of the respective RF coil array.

4. An MR system as claimed in claim 1, wherein the RF coils are formed by planar resonant conductors and that the RF coil arrays include a plurality of mutually perpendicularly arranged strips.

5. An MR system as claimed in claim 1, wherein the RF coils are formed by surface antennas, notably rectangular surface antennas.

6. An MR system as claimed in claim 1, wherein the RF coils are formed by butterfly coils.

7. An MR system as claimed in claim 1, wherein the RF coils of each time one RF coil array are arranged on a single board or on two boards, the means for the decoupling of the individual RF coils then being integrated.

8. An MR system as claimed in claim 1, wherein the control unit is arranged to control the MR system so as to carry out MR imaging in conformity with the SENSE method, for active RF control, for local pre-saturation, for parallel transmission and reception of signals and/or for feedback control of the RF homogeneity.

9. An MR system as claimed in claim 1, wherein the transmit/receive unit comprises n transmit channels which can be controlled independently of one another for the control of amplitude, phase and shape of the excitation pulses.

10. A planar RF coil array for an RF coil system of an MR system as claimed in claim 1 which is to be arranged on opposite sides of the examination zone and is intended for transmitting and/or receiving RF signals by means of at least two RF coils which are decoupled from one another, each RF coil being connectable to a respective channel of a transmit/receive unit of the MR system and each RF coil being separately controllable in the transmission mode.
